(19) United States
(12) Patent Application Publication
(10) Pub. No.: US 2024/0108033 A1
(43) Pub. Date: Apr. 4, 2024

(54) BEVERAGE AND METHOD OF MASKING LIGHT-DETERIORATION ODOR

(71) Applicants: Asahi Group Holdings, Ltd., Tokyo (JP); ASAHI SOFT DRINKS CO., LTD., Tokyo (JP)

(72) Inventors: Eri ICHIKAWA, Ibaraki (JP); Tomoko ISHIBIKI, Ibaraki (JP); Tomoe MIKI, Ibaraki (JP)

(73) Assignees: Asahi Group Holdings, Ltd., Tokyo (JP); ASAHI SOFT DRINKS CO., LTD., Tokyo (JP)

(21) Appl. No.: 18/276,725

(22) PCT Filed: Dec. 14, 2021
(86) PCT No.: PCT/JP2021/046043

§ 371 Date: Aug. 10, 2023

(30) Foreign Application Priority Data
Jul. 2, 2021 (JP) 2021-110767

(51) Int. Cl. A23L 2/42; A23L 2/54; A23L 2/60; A23L 29/00

(52) U.S. Cl. CPC A23L 2/42; A23L 2/54; A23L 2/60; A23L 29/04

(57) ABSTRACT

A beverage comprising an unsaturated fatty acid, comprising: 2.5 to 500 ppb of sabinene and/or 5 to 5000 ppb of γ-terpinene. A method of masking a light-deterioration odor in a beverage comprising an unsaturated fatty acid, by blending sabinene and/or γ-terpinene in such an amount that the content of the sabinene and/or γ-terpinene in the beverage are the amounts noted above.

### TECHNICAL FIELD

The present invention relates to a beverage comprising an unsaturated fatty acid, and the like.

### BACKGROUND ART

Fruit juices and perfumes to be added to beverages sometimes comprise unsaturated fatty acids. When beverages comprising unsaturated fatty acids are exposed to light, components causing an off-flavor, such as (E)-2-decenal and 1-octen-3-one, are produced from the unsaturated fatty acids. As a result, beverages comprising unsaturated fatty acids, which have been exposed to light, cause an off-flavor (also referred to as “light-deterioration odor” hereinafter) during drinking or after drinking.

As a technique to suppress component change due to exposure to light, a technique of adding an antioxidant, such as a tea extract, flavonoid, polyphenol, catechin, or gallic acid, is disclosed in Patent Literature 1.

### CITATION LIST

### Patent Literature

Patent Literature 1
JP2003-159038A

### SUMMARY OF INVENTION

### Technical Problem

If an antioxidant is added to a beverage in order to suppress component change due to exposure to light, the beverage sometimes becomes turbid, and the production cost of the beverage increases.

It is an object of the present invention to provide a novel technique by which a light-deterioration odor in a beverage comprising an unsaturated fatty acid becomes hard to feel.

### Solution to Problem

The present inventor has found that by adding sabinene and/or γ-terpinene to a beverage comprising an unsaturated fatty acid in such a manner that the contents thereof become prescribed ranges, a light-deterioration odor becomes hard to feel, and he has completed the present invention.

The gist of the present invention is as follows.

[1] A beverage comprising an unsaturated fatty acid, comprising 2.5 to 500 ppb of sabinene and/or 5 to 5000 ppb of γ-terpinene.
[2] The beverage according to [1], comprising 0.5 to 500 ppb of (E)-2-decenal.
[3] The beverage according to [1] or [2], comprising both the sabinene and the γ-terpinene.
[4] The beverage according to [3], wherein a content ratio between the sabinene and the γ-terpinene (sabinene:γ-terpinene) is 1:3 to 1:200.
[5] The beverage according to any one of [1] to [4], wherein the beverage is packed in a container having light transmission properties.
[6] The beverage according to any one of [1] to [5], wherein the beverage is a carbonated beverage.
[7] The beverage according to any one of [1] to [6], wherein the beverage is a sugar-sweetened beverage.
[8] The beverage according to any one of [1] to [6], wherein the beverage is a sugar-free beverage.
[9] A method for producing a beverage comprising an unsaturated fatty acid, comprising:

blending sabinene in such an amount that the content of the sabinene in the beverage becomes 2.5 to 500 ppb and/or γ-terpinene in such an amount that the content of the γ-terpinene in the beverage becomes 5 to 5000 ppb.

[10] The method for producing a beverage according to [9], wherein the beverage comprises 0.5 to 500 ppb of (E)-2-decenal.
[11] The method for producing a beverage according to [9] or [10], comprising blending both the sabinene and the γ-terpinene.
[12] The method for producing a beverage according to [11], wherein a content ratio between the sabinene and the γ-terpinene (sabinene:γ-terpinene) is 1:3 to 1:200.
[13] The method for producing a beverage according to any one of [9] to [12], wherein the beverage is packed in a container having light transmission properties.
[14] The method for producing a beverage according to any one of [9] to [13], wherein the beverage is a carbonated beverage.
[15] The method for producing a beverage according to any one of [9] to [14], wherein the beverage is a sugar-sweetened beverage.
[16] The method for producing a beverage according to any one of [9] to [14], wherein the beverage is a sugar-free beverage.
[17] A method of masking a light-deterioration odor in a beverage comprising an unsaturated fatty acid, comprising:

blending sabinene in such an amount that the content of the sabinene in the beverage becomes 2.5 to 500 ppb and/or γ-terpinene in such an amount that the content of the γ-terpinene in the beverage becomes 5 to 5000 ppb.

[18] The method of masking a light-deterioration odor according to [17], wherein the beverage comprises 0.5 to 500 ppb of (E)-2-decenal.
[19] The method of masking a light-deterioration odor according to or [18], comprising blending both the sabinene and the γ-terpinene.
[20] The method of masking a light-deterioration odor according to [19], wherein a content ratio between the sabinene and the γ-terpinene (sabinene:γ-terpinene) is 1:3 to 1:200.
[21] The method of masking a light-deterioration odor according to any one of to [20], wherein the beverage is packed in a container having light transmission properties.
[22] The method of masking a light-deterioration odor according to any one of to [21], wherein the beverage is a carbonated beverage.
[23] The method of masking a light-deterioration odor according to any one of to [22], wherein the beverage is a sugar-sweetened beverage.
[24] The method of masking a light-deterioration odor according to any one of to [22], wherein the beverage is a sugar-free beverage.
[25] A beverage comprising (E)-2-decenal, comprising:

2.5 to 500 ppb of sabinene and/or 5 to 5000 ppb of γ-terpinene.

[26] The beverage according to [25], wherein a content of the (E)-2-decenal is 0.5 to 500 ppb.
[27] The beverage according to or [26], comprising both the sabinene and the γ-terpinene.
[28] The beverage according to [27], wherein a content ratio between the sabinene and the γ-terpinene (sabinene:γ-terpinene) is 1:3 to 1:200.
[29] The beverage according to any one of to [28], wherein the beverage is packed in a container having light transmission properties.
[30] The beverage according to any one of to [29], wherein the beverage is a carbonated beverage.
[31] The beverage according to any one of to [30], wherein the beverage is a sugar-sweetened beverage.
[32] The beverage according to any one of to [30], wherein the beverage is a sugar-free beverage.
[33] The beverage according to any one of to [32], comprising an unsaturated fatty acid.
[34] A method for producing a beverage comprising (E)-2-decenal, comprising:

blending sabinene in such an amount that the content of the sabinene in the beverage becomes 2.5 to 500 ppb and/or γ-terpinene in such an amount that the content of the γ-terpinene in the beverage becomes 5 to 5000 ppb.

[35] The method for producing a beverage according to [34], wherein the beverage comprises 0.5 to 500 ppb of the (E)-2-decenal.
[36] The method for producing a beverage according to [34] or [35], comprising blending both the sabinene and the γ-terpinene.
[37] The method for producing a beverage according to [36], wherein a content ratio between the sabinene and the γ-terpinene (sabinene:γ-terpinene) is 1:3 to 1:200.
[38] The method for producing a beverage according to any one of [34] to [37], wherein the beverage is packed in a container having light transmission properties.
[39] The method for producing a beverage according to any one of [34] to [38], wherein the beverage is a carbonated beverage.
[40] The method for producing a beverage according to any one of [34] to [39], wherein the beverage is a sugar-sweetened beverage.
[41] The method for producing a beverage according to any one of [34] to [39], wherein the beverage is a sugar-free beverage.
[42] The method for producing a beverage according to any one of [34] to [41], wherein the beverage comprises an unsaturated fatty acid.
[43] A method of masking a light-deterioration odor in a beverage comprising (E)-2-decenal, comprising:

blending sabinene in such an amount that the content of the sabinene in the beverage becomes 2.5 to 500 ppb and/or γ-terpinene in such an amount that the content of the γ-terpinene in the beverage becomes 5 to 5000 ppb.

[44] The method of masking a light-deterioration odor according to [43], wherein the beverage comprises 0.5 to 500 ppb of the (E)-2-decenal.
[45] The method of masking a light-deterioration odor according to or [44], comprising blending both the sabinene and the γ-terpinene.
[46] The method of masking a light-deterioration odor according to [45], wherein a content ratio between the sabinene and the γ-terpinene (sabinene:γ-terpinene) is 1:3 to 1:200.
[47] The method of masking a light-deterioration odor according to any one of to [46], wherein the beverage is packed in a container having light transmission properties.
[48] The method of masking a light-deterioration odor according to any one of to [47], wherein the beverage is a carbonated beverage.
[49] The method of masking a light-deterioration odor according to any one of to [48], wherein the beverage is a sugar-sweetened beverage.
[50] The method of masking a light-deterioration odor according to any one of to [48], wherein the beverage is a sugar-free beverage.
[51] The method of masking a light-deterioration odor according to any one of to [50], wherein the beverage comprises an unsaturated fatty acid.

### Advantageous Effect of Invention

According to the present invention, a novel technique by which a light-deterioration odor in a beverage comprising an unsaturated fatty acid becomes hard to feel can be provided.

### BRIEF DESCRIPTION OF DRAWINGS

FIG. 1a is a graph showing evaluation results of Test 1-1.

FIG. 1b is a graph showing evaluation results of Test 1-2.

FIG. 2a is a graph showing evaluation results of Test 2-1.

FIG. 2b is a graph showing evaluation results of Test 2-2.

FIG. 3a is a graph showing evaluation results of Test 3-1.

FIG. 3b is a graph showing evaluation results of Test 3-2.

FIG. 4a is a graph showing evaluation results of Test 4-1.

FIG. 4b is a graph showing evaluation results of Test 4-2.

### DESCRIPTION OF EMBODIMENTS

Hereinafter, one embodiment of the present invention will be described.

The beverage of the present embodiment is a beverage comprising an unsaturated fatty acid, and comprises 2.5 to 500 ppb of sabinene and/or 5 to 5000 ppb of γ-terpinene.

The unsaturated fatty acid comprised in the beverage of the present embodiment is a fatty acid having an unsaturated bond. The origin of the unsaturated fatty acid is not particularly limited, and for example, it may be an unsaturated fatty acid comprised in fruit juice having been added as a raw material of the beverage, may be an unsaturated fatty acid comprised in perfume having been added as a raw material of the beverage, or may be an unsaturated fatty acid comprised in both of fruit juice and perfume having been added as raw materials of the beverage. Examples of the unsaturated fatty acids include oleic acid, linoleic acid, a-linolenic acid, and γ-linolenic acid.

The content of the unsaturated fatty acid in the beverage of the present embodiment can be appropriately set according to a desired flavor of the beverage, etc., and is not particularly limited. As one example, a beverage in which the total content of unsaturated fatty acids is 1 ppb or more can be judged to be a beverage comprising an unsaturated fatty acid, and as another example, a beverage in which the total content of oleic acid and linoleic acid is 1 ppb or more can be judged to be a beverage comprising an unsaturated fatty acid. The unsaturated fatty acid comprised in a beverage can be quantitatively determined by carrying out target analysis using a high-performance liquid chromatograph mass spectrometer. When an unsaturated fatty acid (unsaturated fatty acid derived from fruit juice) is blended into the beverage by blending fruit juice into the beverage, the content of the fruit juice can be set to, for example, 1 to 30% by mass based on 100% by mass of the beverage.

Examples of the fruit juices that can be comprised in the beverage of the present embodiment include fruit juices of lemon, grapefruit, Yuzu, lime, flat lemon, orange, mandarin orange, peach, grape, strawberry, plum, apple, Japanese pear, pear, and the like. Among these fruit juices, citrus juices of lemon, grapefruit, Yuzu, lime, flat lemon, orange, mandarin orange, and the like are preferable because they have good compatibility with sabinene and γ-terpinene, and lemon juice is more preferable. The fruit juices may be blended singly, or may be blended in combination of two or more.

In the present specification, fruit juice refers to a liquid component obtained by juice extraction from fruit, and juice extraction refers to an operation of squeezing a liquid component from fruit to separate the liquid component. The fruit juice can be obtained by, for example, crushing fruit to appropriate size and extracting juice from the crushed fruit. The method of juice extraction is not particularly limited, and can be carried out by a conventional method using a usual squeezer, and for example, a Brown (paddle type) or butterfly type pulper finisher can be used. The fruit juice may be one having been subjected to clarification treatment, such as a microfiltration method, an enzymatic treatment method, or an ultrafiltration method, after the juice extraction.

In the beverage comprising an unsaturated fatty acid, a component causing an off-flavor, such as (E)-2-decenal or 1-octen-3-one, (also referred to as “an odor component” hereinafter) is produced from the unsaturated fatty acid by exposure of the beverage to light. When the beverage comprising an odor component does not comprise prescribed amounts of sabinene and/or γ-terpinene (sabinene: 2.5 to 500 ppb, γ-terpinene: 5 to 5000 ppb), an off-flavor (also referred to as “light-deterioration odor” hereinafter) is felt during drinking or after drinking due to the effect of the odor component comprised in the beverage. The light-deterioration odor specifically refers to a metallic smell, an oxidized oil smell, a resin odor, or such an unpleasant smell as evokes a stink bug.

The odor component may be comprised in the beverage of the present embodiment by adding a raw material comprising the odor component, but it may not be comprised in the raw material of the beverage. That is to say, the odor component may be comprised in the beverage obtained immediately after production, or may not be comprised in the beverage obtained immediately after production. Even if an odor component is not comprised in the beverage obtained immediately after production, an odor component is generated by light exposure if an unsaturated fatty acid is comprised in the beverage. Therefore, the presence or absence of an odor component in the beverage obtained immediately after production is not particularly limited.

The content of the odor component in the beverage is not particularly limited. From the viewpoint that a light-deterioration odor in the beverage becomes hard to feel, the content of (E)-2-decenal in the beverage is preferably 0.5 to 500 ppb, more preferably 0.5 to 100 ppb, and particularly preferably 1 to 10 ppb. In the present specification, the content of the odor component refers to a content between production of the beverage and consumption (drinking) of the beverage. The content of the odor component in the prescribed range indicates that the content thereof is in the prescribed range at least at some time between production of the beverage and consumption thereof (for example, when the accumulated illuminance of light (light from light-emitting diode, or the like) on the beverage becomes 1,000,000 to 10,000,000 lx·hr, or when 1 day to 10 days have passed since the display of the beverage on a display shelf that is irradiated with light (light from light-emitting diode, or the like)), so that it does not mean only that the content is continuously in the prescribed range from production of the beverage to consumption thereof, and it also means that the content is out of the prescribed range immediately after production but comes into the prescribed range by the time the beverage is consumed. In the present specification, ppb means ppb by mass.

In the beverage of the present embodiment, 2.5 to 500 ppb of sabinene and/or 5 to 5000 ppb of γ-terpinene are comprised in addition to the above-mentioned unsaturated fatty acid. Since the contents of the sabinene and/or the γ-terpinene in the beverage of the present embodiment are in their respective content ranges mentioned above (sabinene: 2.5 to 500 ppb, γ-terpinene: 5 to 5000 ppb), a light-deterioration odor becomes hard to feel during drinking of the beverage or after drinking thereof.

Sabinene (1-isopropyl-4-methylenebicyclo[3.1.0]hexane) is bicyclic monoterpene, and is, for example, a substance contained in spices such as nutmeg. γ-Terpinene (4-isopropyl-1-methyl-1,4-cyclohexadiene) is monoterpene having a p-menthane skeleton, and is, for example, a substance contained in plants such as coriander.

The sabinene and the γ-terpinene in the beverage of the present embodiment may be those obtained by chemical synthesis, or may be those obtained by subjecting natural products to extraction/purification. The origins of the sabinene and the γ-terpinene in the beverage of the present embodiment are not particularly limited, and for example, the sabinene and/or the γ-terpinene may be comprised in the beverage of the present embodiment by adding, as raw materials, perfumes comprising sabinene and/or γ-terpinene to the beverage.

The beverage of the present embodiment may comprise at least one of sabinene and γ-terpinene, and may comprise only one of them. Here, when the contents of sabinene and/or γ-terpinene are in their respective content ranges mentioned above (sabinene: 2.5 to 500 ppb, γ-terpinene: 5 to 5000 ppb), they have less adverse effect on a flavor of the whole citrus-flavored beverage (that is, citrus flavor). On this account, when the beverage of the present embodiment is allowed to have a citrus flavor, less adverse effect is exerted on the flavor (citrus flavor) of the whole beverage even if either sabinene or γ-terpinene is incorporated, but when the content of γ-terpinene is 1000 ppb or more (1000 to 5000 ppb), incorporation of sabinene into the beverage exerts much less adverse effect on the flavor (citrus flavor) of the whole beverage than incorporation of γ-terpinene. For this reason, when only one of sabinene and γ-terpinene is incorporated into the beverage of the present embodiment having a citrus flavor, incorporation of sabinene only is preferable to incorporation of γ-terpinene only.

Although the beverage of the present embodiment may comprise only one of sabinene and γ-terpinene, it preferably comprises both of sabinene and γ-terpinene. In the beverage comprising both of sabinene and γ-terpinene, a light-deterioration odor becomes harder to feel, as compared with that in the beverage comprising only one of sabinene and γ-terpinene.

In the beverage comprising both of sabinene and γ-terpinene, the content ratio between the sabinene and the γ-terpinene can be appropriately set within their respective content ranges mentioned above (sabinene: 2.5 to 500 ppb, γ-terpinene: 5 to 5000 ppb), and is not particularly limited. From the viewpoint that a light-deterioration odor in the beverage is made to become hard to feel while an adverse effect on the flavor of the whole beverage is suppressed, the content ratio between the sabinene and the γ-terpinene (sabinene:γ-terpinene) is preferably 1:3 to 1:200, and more preferably 1:3 to 1:100.

When the beverage of the present embodiment comprises sabinene, the content ratio between an odor component and the sabinene is not particularly limited, but from the viewpoint that a light-deterioration odor in the beverage is made to become hard to feel while an adverse effect on the flavor of the whole beverage is suppressed, the content ratio between (E)-2-decenal and sabinene ((E)-2-decenal:sabinene) is preferably set to 1:0.02 to 1:10, and more preferably set to 1:0.05 to 1:4.

When the beverage of the present embodiment comprises γ-terpinene, the content ratio between an odor component and the γ-terpinene is not particularly limited, but from the viewpoint that a light-deterioration odor in the beverage is made to become hard to feel while an adverse effect on the flavor of the whole beverage is suppressed, the content ratio between (E)-2-decenal and γ-terpinene ((E)-2-decenal:γ-terpinene) is preferably set to 1:0.1 to 1:100, and more preferably set to 1:0.15 to 1:40.

In the present specification, the adverse effect on the flavor of the whole beverage indicates that as compared with a flavor of a beverage having the same composition except for no addition of sabinene and γ-terpinene, a different flavor is felt.

When the beverage of the present embodiment comprises sabinene, the content of the sabinene is 2.5 to 500 ppb, but from the viewpoint that a light-deterioration odor in the beverage is made to become hard to feel while an adverse effect on the flavor of the whole beverage is suppressed, the content thereof is preferably 2.5 to 200 ppb, more preferably 7.0 to 200 ppb, and particularly preferably 10.0 to 200 ppb. When the beverage of the present embodiment comprises γ-terpinene, the content of the γ-terpinene is 5 to 5000 ppb, but from the viewpoint that a light-deterioration odor in the beverage is made to become hard to feel while an adverse effect on the flavor of the whole beverage is suppressed, the content thereof is preferably 7.5 to 2000 ppb.

The contents of the sabinene, the γ-terpinene, and the odor component in the beverage can be measured by, for example, a dichloromethane extraction method using a gas chromatograph mass spectrometer (GC/MS), or the like. For the quantitative determination, for example, calculation can be carried out by an internal standard method using heptan-3-ol based on a relationship between a peak area ratio of a target component to an internal standard substance and a content ratio thereof. When the addition amounts of sabinene and γ-terpinene used as raw materials of the beverage are known, the contents of the sabinene and the γ-terpinene may be determined by calculation using the addition amounts thereof and the mass of the beverage.

In addition to the above-mentioned unsaturated fatty acid, sabinene and/or γ-terpinene, and drinking water (raw material water), the beverage of the present embodiment may comprise other components as long as the object of the invention as claimed in the application concerned can be achieved. Examples of such other components include a sweetener (saccharides, high intensity sweetener, etc.), perfume, a coloring matter component, fruit juice, a pH adjuster, an antioxidant (oxidation inhibitor), a preservative, a seasoning, an acidulant, vitamins, and amino acid.

The beverage of the present embodiment can be made to serve as a flavored beverage having been flavored by fruit juice, perfume, or the like. Since the sabinene and the γ-terpinene in the beverage of the present embodiment have less adverse effect on a citrus flavor, the beverage of the present embodiment is preferably a citrus-flavored beverage among flavored beverages, and is more preferably a lemon-flavored beverage. The citrus-flavored beverage refers to a beverage with a flavor that evokes citrus fruit.

When the beverage of the present embodiment is made to serve as a citrus-flavored beverage, it is preferable that the beverage should not have other flavors different from a citrus flavor (also referred to as “other flavors” hereinafter). Examples of the other flavors different from a citrus flavor include a spice flavor and a beer flavor (beer taste).

The above-mentioned spice flavor is a flavor that evokes a spice, and examples thereof include a cinnamon flavor that evokes cinnamon, a ginger flavor that evokes ginger, an herb flavor that evokes herb, a cassia flavor that evokes cassia, and a clove flavor that evokes clove. A cola-flavored beverage is a beverage having a spice flavor in addition to a citrus flavor, and it is preferable that the beverage of the present embodiment should not have other flavors different from a citrus flavor, such as a cola flavor. The above-mentioned beer flavor is a flavor that evokes beer.

The beverage of the present embodiment can be made to serve as a sugar-free beverage that does not substantially comprise saccharides. In the Nutrition Labeling Standards based on the Health Promotion Act in Japan, a beverage comprising less than 0.5 g of saccharides per 100 ml of the beverage can be labeled as sugar-free, and therefore, in the present specification also, a beverage having a saccharide content of less than 0.5 g per 100 ml is referred to as a sugar-free beverage similarly to the above provisions. When the beverage of the present embodiment is made to serve as a sugar-free beverage, it may be a sugar-free beverage having a saccharide content of 0.0 g. Since the sugar-free beverage comprises no saccharides, an effect of a component comprised on palatability is more easily exerted than that in a sugar-sweetened beverage. Thus, in general, a sugar-free beverage tends to be restricted on components that can be comprised and their contents as compared with a sugar-sweetened beverage.

The beverage of the present embodiment can also be made to serve as a sugar-sweetened beverage having a saccharide content of 0.5 g or more per 100 ml. From the viewpoint that a light-deterioration odor in a beverage is made to become hard to feel, a sugar-sweetened beverage is preferable to a sugar-free beverage, as the beverage of the present embodiment. When the beverage of the present embodiment is a sugar-sweetened beverage, the sugar content (Brix value) thereof is not particularly limited, but for example, it can be set to 1 to 15. In the present specification, the sugar content (Brix value) is a sugar refractometer index at 20° C., and for example, it can be measured using a digital refractometer RX-5000α (manufactured by ATAGO CO., LTD.).

In the beverage of the present embodiment, the acidity [g/100 ml] may be adjusted by adding an acidulant, or the like. The acidity of the beverage is not particularly limited, and can be appropriately set according to the taste of the beverage, but when the beverage of the present embodiment is a sugar-sweetened beverage, the acidity is preferably 0.05 to 0.5 from the viewpoint of enhancing palatability. The acidity is the number of grams [citric anhydride g/100 ml] given when the amount of an organic acid contained in 100 ml of a beverage is converted into that of citric acid. The acidity of a beverage can be measured by a method defined in the acidity measurement method of JAS, specifically, a neutralization titration method (quantitative manner) using a 0.1 mol/L sodium hydroxide standard solution as an alkaline solution.

The beverage of the present embodiment can be made to serve as a carbonated beverage in which carbon dioxide gas is dissolved. When the beverage of the present embodiment is made to serve as a carbonated beverage, the carbon dioxide gas volume is not particularly limited and can be set within a general range for a carbonated beverage, but it can be set to, for example, 1.5 vol to 5.0 vol.

The carbon dioxide gas volume [vol] refers to a ratio of a volume of carbon dioxide gas dissolved in a carbonated beverage to a volume of the carbonated beverage at 1 atmosphere and 20° C. The carbon dioxide gas volume can be measured using, for example, commercially available measuring equipment (Gas Volume Analyzer GVA-500A manufactured by Kyoto Electronics Manufacturing Co., Ltd.). More specifically, the carbon dioxide gas volume can be obtained by setting a sample to 20° C., then installing an internal gas pressure gauge, opening a stopper cock once to carry out a degassing (snifting) operation, closing the stopper cock immediately, then vigorously shaking the sample, and carrying out calculation from a value obtained when the pressure becomes constant.

The beverage of the present embodiment can be made to serve as a container-packed beverage wherein the beverage is packed in a container. The container in which the beverage is to be packed is not particularly limited, but for example, it can be a container having light transmission properties. The beverage packed in a container having light transmission properties is exposed to light even after it is packed, and therefore, an odor component is generated from an unsaturated fatty acid even in the container.

In the present specification, having light transmission properties means that the contents can be directly observed through a container, and the container preferably transmits at least light of 380 nm or more and 750 nm or less that is a visible light region. The light transmittance of the container in this wavelength region can be set to, for example, 50% or more, is preferably set to 70% or more, and is more preferably set to 80% or more.

The container having light transmission properties does not need to be transparent through the whole, and it may be a container that is partially transparent. For example, it may be a container wherein a label or a printed part for content display is opaque or translucent and other parts are transparent, or may be a container wherein a part having light transmission properties and a part having no light transmission properties are irregularly or regularly arranged.

The container in which the beverage is to be packed is not limited, and for example, a bottle made of glass, a plastic container such as a PET bottle, or a metallic can such as a steel can or an aluminum can can be used. Examples of the containers having light transmission properties include bottles made of glass, and containers of plastics such as polyethylene, polypropylene, polyethylene terephthalate (PET), polyethylene naphthalate (PEN), an ethylene/1-alkene copolymer, nylon, polystyrene, and vinyl chloride.

The appearance of the beverage of the present embodiment is not particularly limited, but it can be made transparent, such as colorless and transparent. In the present specification, a transparent beverage refers to a beverage having an absorbance of 0.01 or less at 720 nm. The term colorless and transparent refers to a state of an appearance that can be seen through, has no specific color, and is the same as that of water. The absorbance at 720 nm can be measured by, for example, taking a light path length to be 1 cm using a spectrophotometer. The transparent beverage is restricted on usage of components for coloring the beverage. Thus, in general, a transparent beverage tends to be restricted on components that can be comprised and their contents as compared with a non-transparent beverage.

Next, one example of a method for producing the beverage of the present embodiment will be described.

The beverage of the present embodiment can be produced by blending sabinene in such an amount that the content thereof in the beverage becomes 2.5 to 500 ppb and/or γ-terpinene in such an amount that the content thereof in the beverage becomes 5 to 5000 ppb (this treatment is also referred to as “blend treatment” hereinafter).

In the blend treatment, in addition to the blend of sabinene in drinking water in such an amount that the content thereof in the beverage becomes 2.5 to 500 ppb and/or γ-terpinene therein in such an amount that the content thereof in the beverage becomes 5 to 5000 ppb, raw materials other than the sabinene and the γ-terpinene (excluding drinking water) may be blended in the drinking water. The order of addition of the raw materials (unsaturated fatty acid, sabinene, γ-terpinene, and other components) to the drinking water is not particularly limited, and the raw materials may be successively added to the drinking water, or the raw materials may be added to the drinking water at the same time.

According to the blend treatment including the above-mentioned incorporation treatment, the beverage of the present embodiment can be produced.

When the beverage of the present embodiment is made to serve as a carbonated beverage, the carbonated beverage of the present embodiment can be produced by carrying out, in addition to the above-mentioned blend treatment, dissolution treatment in which carbon gas is incorporated in a beverage obtained after the blend treatment (drinking water to which raw materials have been added).

The method for incorporating carbon dioxide gas in the beverage in the dissolution treatment is not particularly limited, and for example, a method of mixing drinking water in which carbon dioxide gas has been dissolved in advance with the beverage obtained after the blend treatment (post-mix method), or a method of blowing carbon gas into the beverage obtained after the blend treatment to dissolve it (pre-mix method) can be used.

Here, in the post-mix method, drinking water (carbonated water) in which carbon dioxide gas has been dissolved in advance is mixed with the beverage obtained after the blend treatment, so that the contents of sabinene and γ-terpinene change before and after the dissolution treatment. Thus, when the post-mix method is used in the dissolution treatment, the contents of sabinene and γ-terpinene in the incorporation treatment are adjusted taking into consideration the amount of a carbonated water to be mixed. Specifically, in the blend treatment, sabinene and/or γ-terpinene are blended in drinking water in such amounts that the contents of the sabinene and/or the γ-terpinene in the beverage obtained after the dissolution treatment are in the above-mentioned ranges (sabinene: 2.5 to 500 ppb, γ-terpinene: 5 to 5000 ppb).

When the beverage of the present embodiment is made to serve as a container-packed beverage, the container-packed beverage of the present embodiment can be produced by carrying out, in addition to the above-mentioned blend treatment, filling treatment in which a container is filled with the beverage obtained after the incorporation treatment. The filling of the container with the beverage can be carried out in accordance with a conventional method, and is not particularly limited. When the beverage of the present embodiment is made to serve as a container-packed carbonated beverage, the container-packed carbonated beverage of the present embodiment can be produced by carrying out dissolution treatment after the above-mentioned blend treatment and carrying out filling treatment in which a container is filled with a carbonated beverage obtained after the dissolution treatment.

In the beverage of the present embodiment described above, sabinene and/or γ-terpinene comprised in the prescribed amounts (sabinene: 2.5 to 500 ppb, γ-terpinene: 5 to 5000 ppb) make a light-deterioration odor, which is derived from an odor component, become hard to feel. Thus, the beverage of the present embodiment makes a light-deterioration odor become hard to feel during drinking or after drinking as compared with a beverage that does not comprise sabinene and/or γ-terpinene.

According to the beverage of the present embodiment, moreover, a light-deterioration odor can be made to become hard to feel irrespective of the presence or absence of an antioxidant, and therefore, turbidity of a beverage and increase in cost that can be brought about by the addition of an antioxidant can also be suppressed.

The sabinene and/or the γ-terpinene comprised in the beverage of the present embodiment in the prescribed amounts (sabinene: 2.5 to 500 ppb, γ-terpinene: 5 to 5000 ppb) make a drinker who has drunken the beverage not easily feel a light-deterioration odor, and therefore, a method of masking a light-deterioration odor in a beverage comprising an unsaturated fatty acid, which comprises blending sabinene in such an amount that the content thereof in the beverage becomes 2.5 to 500 ppb and/or γ-terpinene in such an amount that the content thereof in the beverage becomes 5 to 5000 ppb, can be provided as one embodiment of the present invention.

### EXAMPLES

Hereinafter, the present invention will be more specifically described with examples, but the present invention is not limited thereto.

### Evaluation 1-1 (Effect of (E)-2-Decenal in Sugar-Free Carbonated Beverage)

Citral was added to drinking water, and in addition, carbon dioxide gas was dissolved in the drinking water by a post-mix method, thereby obtaining a lemon-flavored sugar-free carbonated beverage. This lemon-flavored sugar-free carbonated beverage had a citral content of 10 ppm and a carbon dioxide gas volume of 4.0 vol. The resulting lemon-flavored sugar-free carbonated beverage was taken to be a beverage (undeteriorated product (colorless and transparent)) of Reference Example 1.

In the step of adding citral in Reference Example 1, (E)-2-decenal was further added to blend the (E)-2-decenal (odor component) into the lemon-flavored sugar-free carbonated beverage of Reference Example 1. Except for this, sugar-free carbonated beverages (deteriorated products (colorless and transparent)) of Reference Examples 2 to 5 shown in Table 1a below were obtained in the same manner as in Reference Example 1.

Five panelists tasted the beverages of Reference Examples 1 to 5, and they evaluated “flavor of whole beverage” and “light-deterioration odor” based on the evaluation criteria described later. As the panelists, suitable persons such as sensory evaluation specialists and beverage developers were selected, and persons having extreme likes and dislikes, persons having allergies, and the like were excluded.

<Evaluation Criteria for “Flavor of Whole Beverage”>

The “flavor of whole beverage” was evaluated on a five-point scale of 1 point to 5 points, and as the score approached 1 point from 5 points, the flavor of the whole beverage became poorer. In order to standardize the evaluation criteria among the panelists, a beverage having a flavor equivalent to that of the undeteriorated product (Reference Example 1 in the present evaluation) was rated 5 points, and the evaluation was carried out by allowing the panelists to have a common understanding that poor flavor means that a flavor different from the flavor (that is, lemon flavor) of the undeteriorated product (Reference Example 1 in the present evaluation) is felt.

1 point: Flavor of the whole beverage is poor.

2 points: Flavor of the whole beverage is slightly poor.

3 points: Flavor of the whole beverage is neither poor nor good.

4 points: Flavor of the whole beverage is slightly good.

5 points: Flavor of the whole beverage is good (equivalent to undeteriorated product).

<Evaluation Criteria for “Light-Deterioration Odor”>

The “light-deterioration odor” was evaluated on a five-point scale of 1 point to 5 points, and as the score approached 1 point from 5 points, a light-deterioration odor was more strongly felt. In order to standardize the evaluation criteria among the panelists, a beverage having a light-deterioration odor, which was equivalent to that of the undeteriorated product (Reference Example 1 in the present evaluation), was rated 5 points, and the evaluation was carried out by allowing the panelists to have a common understanding that a light-deterioration odor means a metallic smell, an oxidized oil smell, a resin odor, or such an unpleasant smell as evokes a stink bug.

1 point: Light-deterioration odor is strong.

2 points: Light-deterioration odor is slightly strong.

3 points: Light-deterioration odor is neither strong nor weak.

4 points: Light-deterioration odor is slightly weak.

5 points: Light-deterioration odor is weak (equivalent to undeteriorated product).

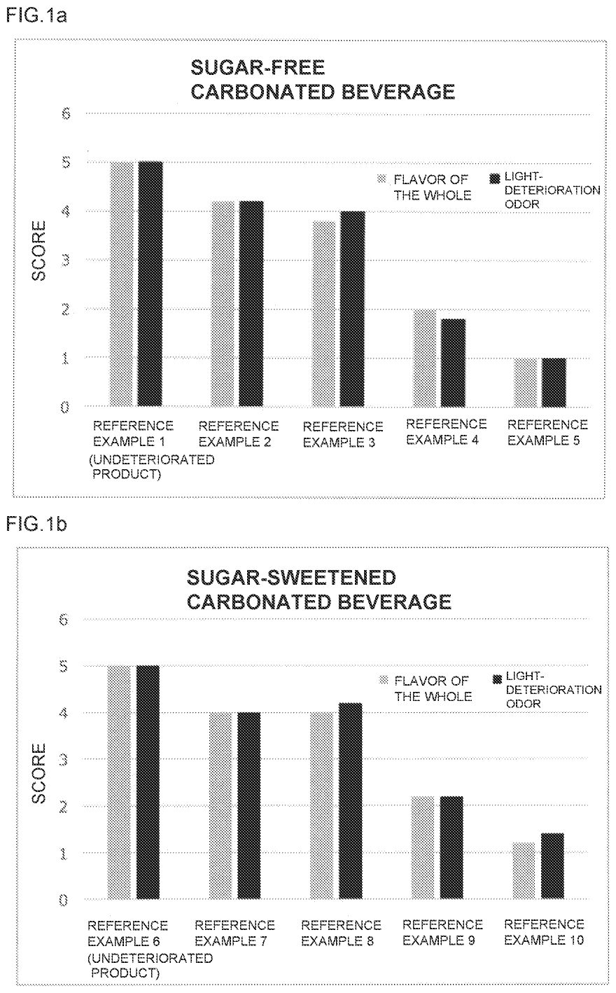

The evaluation results of the carbonated beverages of Reference Examples 1 to 5 are shown in Table 1a and FIG. 1a.

TABLE 1a

| | Reference Example | | | | |
|---|---|---|---|---|---|
| | 1 | | | | |
| Sugar-free | (Undeteriorated | | | | |
| carbonated beverage | product) | 2 | 3 | 4 | 5 |
| (E)-2-Decenal (ppb) | 0 | 5 | 10 | 50 | 100 |
| Flavor of whole beverage | 5 | 4.2 | 3.8 | 2 | 1 |
| Light-deterioration odor | 5 | 4.2 | 4 | 1.8 | 1 |

As shown in Table 1a and FIG. 1a, when (E)-2-decenal was comprised in the sugar-free carbonated beverage, a light-deterioration odor was more strongly felt as its content was increased. Moreover, the flavor of the whole beverage became poorer as the content of (E)-2-decenal was increased.

### [Evaluation 1-2 (Effect of (E)-2-Decenal in Sugar-Sweetened Beverage)

Citral, an acid (citric acid), and sugar (high-fructose corn syrup) were added to drinking water, and in addition, carbon dioxide gas was dissolved in the drinking water by a post-mix method, thereby obtaining a lemon-flavored sugar-sweetened carbonated beverage. This lemon-flavored sugar-sweetened carbonated beverage had a citral content of 10 ppm, a carbon dioxide gas volume of 4.0 vol, a sugar content (Brix value) of 5, and an acidity of 0.1. The resulting lemon-flavored sugar-sweetened carbonated beverage was taken to be a beverage (undeteriorated product (colorless and transparent)) of Reference Example 6.

In the step of adding citral, an acid, and sugar in Reference Example 6, (E)-2-decenal was further added to blend the (E)-2-decenal into the lemon-flavored sugar-sweetened carbonated beverage of Reference Example 6. Except for this, sugar-sweetened carbonated beverages (deteriorated products (colorless and transparent)) of Reference Examples 7 to 10 shown in Table 1b below were obtained in the same manner as in Reference Example 6.

Regarding the resulting beverages of Reference Examples 6 to 10, “flavor of whole beverage” and “light-deterioration odor” were evaluated based on the same evaluation criteria as in Evaluation 1-1. In the present evaluation, the undeteriorated product (that is, 5 points) in the evaluation criteria for “flavor of whole beverage” and “light-deterioration odor” was taken to be the carbonated beverage of Reference Example 6.

The evaluation results of the carbonated beverages of Reference Examples 6 to 10 are shown in Table 1b and FIG. 1b.

TABLE 1b

| | Reference Example | | | | |
|---|---|---|---|---|---|
| | 6 | | | | |
| Sugar-sweetened | (Undeteriorated | | | | |
| carbonated beverage | product) | 7 | 8 | 9 | 10 |
| Odor component (ppb) | 0 | 5 | 10 | 50 | 100 |
| Flavor of whole beverage | 5 | 4 | 4 | 2.2 | 1.2 |
| Light-deterioration odor | 5 | 4 | 4.2 | 2.2 | 1.4 |

As shown in Table 1b and FIG. 1b, even when (E)-2-decenal was blended into the sugar-sweetened carbonated beverage, a light-deterioration odor was more strongly felt as the content of (E)-2-decenal was increased. Moreover, the flavor of the whole beverage also became poorer as the content of (E)-2-decenal was increased.

### Evaluation 2-1 (Effect of Sabinene on Light-Deterioration Odor in Sugar-Free Carbonated Beverage)

In the step of adding raw materials in Reference Example 4 in Evaluation 1-1, sabinene was further added to blend the sabinene into the sugar-free carbonated beverage of Reference Example 4. Except for this, sugar-free carbonated beverages (colorless and transparent) of Examples 1 to 4 shown in Table 2a below were obtained in the same manner as in Reference Example 4.

For comparison with the beverages of Examples 1 to 4, Reference Example 1 and Reference Example 4 in Evaluation 1-1 were prepared, and these were taken to be an undeteriorated product (Reference Example 1) and a deteriorated product (Reference Example 4).

Five panelists tasted the beverages of Examples 1 to 4, and they evaluated “flavor of whole beverage” and “light-deterioration odor” based on the evaluation criteria described later. As the panelists, suitable persons such as sensory evaluation specialists and beverage developers were selected, and persons having extreme likes and dislikes, persons having allergies, and the like were excluded.

<Evaluation Criteria for “Flavor of Whole Beverage”>

The “flavor of whole beverage” was evaluated on a five-point scale of 1 point to 5 points, and as the score approached 1 point from 5 points, the flavor of the whole beverage became poorer. In order to standardize the evaluation criteria among the panelists, a beverage having a flavor equivalent to that of the undeteriorated product (Reference Example 1 in the present evaluation) was rated 5 points, and a beverage having a flavor equivalent to that of the deteriorated product (Reference Example 4 in the present evaluation) was rated 1 point. Similarly to Evaluation 1-1, the evaluation was carried out by allowing the panelists to have a common understanding that poor flavor means that a flavor different from the flavor (that is, lemon flavor) of the undeteriorated product (Reference Example 1 in the present evaluation) is felt.

1 point: Flavor of the whole beverage is poor (equivalent to deteriorated product).

2 points: Flavor of the whole beverage is slightly poor.

3 points: Flavor of the whole beverage is neither poor nor good.

4 points: Flavor of the whole beverage is slightly good.

5 points: Flavor of the whole beverage is good (equivalent to undeteriorated product).

<Evaluation Criteria for “Light-Deterioration Odor”>

The “light-deterioration odor” was evaluated on a five-point scale of 1 point to 5 points, and as the score approached 1 point from 5 points, a light-deterioration odor was more strongly felt. In order to standardize the evaluation criteria among the panelists, a beverage having a light-deterioration odor, which was equivalent to that of the undeteriorated product (Reference Example 1 in the present evaluation), was rated 5 points, and a beverage having a light-deterioration odor, which was equivalent to that of the deteriorated product (Reference Example 4 in the present evaluation), was rated 1 point. Similarly to Evaluation 1-1, the evaluation was carried out by allowing the panelists to have a common understanding that a light-deterioration odor means a metallic smell, an oxidized oil smell, a resin odor, or such an unpleasant smell as evokes a stink bug.

1 point: Light-deterioration odor is strong (equivalent to deteriorated product).

2 points: Light-deterioration odor is slightly strong.

3 points: Light-deterioration odor is neither strong nor weak.

4 points: Light-deterioration odor is slightly weak. 5 points: Light-deterioration odor is weak (equivalent to undeteriorated product).

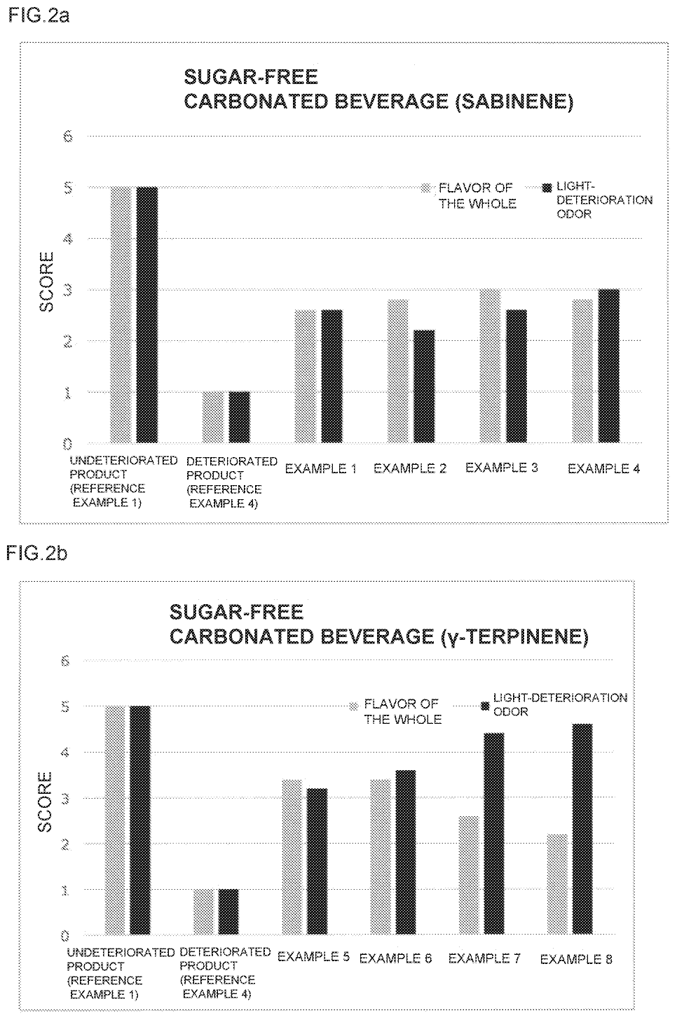

The evaluation results of the beverages of Examples 1 to 4 are shown in Table 2a and FIG. 2a.

TABLE 2a

| | Undeteri- | Deteri- | | | | |
|---|---|---|---|---|---|---|
| | orated | orated | | | | |
| | product | product | | | | |
| | (Reference | (Reference | | | | |
| Sugar-free | Example | Example | Example | | | |
| carbonated beverage | 1) | 4) | 1 | 2 | 3 | 4 |
| Odor | 0 | 50 | 50 | 50 | 50 | 50 |
| component (ppb) | | | | | | |
| Sabinene (ppb) | 0 | 0 | 5 | 50 | 100 | 200 |
| Flavor of the whole | 5 | 1 | 2.6 | 2.8 | 3.0 | 2.8 |
| Light-deterioration | 5 | 1 | 2.6 | 2.2 | 2.6 | 3.0 |
| odor | | | | | | |

As shown in Table 2a and FIG. 2a, in the beverages of Examples 1 to 4, a light-deterioration odor became harder to feel, and the flavor of the whole was improved, as compared with those in the deteriorated product (Reference Example 4) comprising no sabinene.

### Evaluation 2-2 (Effect of γ-Terpinene on Light-Deterioration Odor in Sugar-Free Carbonated Beverage)

In the step of adding raw materials in Reference Example 4 in Evaluation 1-1, γ-terpinene was further added to blend the γ-terpinene into the sugar-free carbonated beverage of Reference Example 4. Except for this, sugar-free carbonated beverages (colorless and transparent) of Examples 5 to 8 shown in Table 2b below were obtained in the same manner as in Reference Example 4.

For comparison with the beverages of Examples 5 to 8, Reference Example 1 and Reference Example 4 in Evaluation 1-1 were prepared, and these were taken to be an undeteriorated product (Reference Example 1) and a deteriorated product (Reference Example 4).

Five panelists tasted the beverages of Examples 5 to 8, and they evaluated “flavor of whole beverage” and “light-deterioration odor” based on the same evaluation criteria as in Evaluation 2-1.

The evaluation results of the beverages of Examples 5 to 8 are shown in Table 2b and FIG. 2b.

TABLE 2b

| | Undeteriorated | Deteriorated | | | | |
|---|---|---|---|---|---|---|
| | product | product | | | | |
| Sugar-free | (Reference | (Reference | Example | | | |
| carbonated beverage | Example 1) | Example 4) | 5 | 6 | 7 | 8 |
| Odor component (ppb) | 0 | 50 | 50 | 50 | 50 | 50 |
| γ-Terpinene (ppb) | 0 | 0 | 15 | 150 | 1500 | 2000 |
| Flavor of the whole | 5 | 1 | 3.4 | 3.4 | 2.6 | 2.2 |
| Light-deterioration odor | 5 | 1 | 3.2 | 3.6 | 4.4 | 4.6 |

As shown in Table 2b and FIG. 2b, in the beverages of Examples 5 to 8, a light-deterioration odor became harder to feel, and the flavor of the whole was improved, as compared with those in the deteriorated product (Reference Example 4) comprising no γ-terpinene.

### Evaluation 3-1 (Effect of Sabinene on Light-Deterioration Odor in Sugar-Sweetened Carbonated Beverage)

In the step of adding raw materials in Reference Example 9 in Evaluation 1-2, sabinene was further added to blend the sabinene into the sugar-sweetened carbonated beverage of Reference Example 9. Except for this, sugar-sweetened carbonated beverages (colorless and transparent) of Examples 9 to 12 shown in Table 3a below were obtained in the same manner as in Reference Example 9.

For comparison with the beverages of Examples 9 to 12, Reference Example 6 and Reference Example 9 in Evaluation 1-2 were prepared, and these were taken to be an undeteriorated product (Reference Example 6) and a deteriorated product (Reference Example 9).

Five panelists tasted the carbonated beverages of Examples 9 to 12, and they evaluated “flavor of whole beverage” and “light-deterioration odor” based on the same criteria as in Evaluation 2-1. In the present evaluation, the undeteriorated product (that is, 5 points) in the evaluation criteria for “flavor of whole beverage” and “light-deterioration odor” was taken to be Reference Example 6, and the deteriorated product (that is, 1 point) therein was taken to be Reference Example 9.

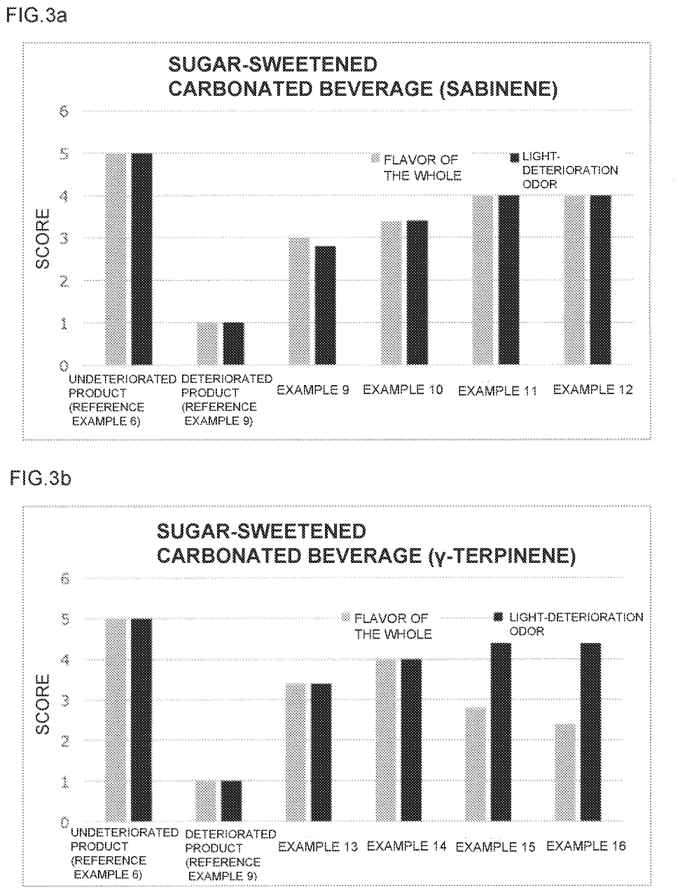

The evaluation results of the carbonated beverages of Examples 9 to 12 are shown in Table 3a and FIG. 3a.

TABLE 3a

| | Undeteri- | Deteri- | | | | |
|---|---|---|---|---|---|---|
| | orated | orated | | | | |
| | product | product | | | | |
| | (Reference | (Reference | | | | |
| Sugar-sweetened | Example | Example | Example | | | |
| carbonated beverage | 6) | 9) | 9 | 10 | 11 | 12 |
| Odor | 0 | 50 | 50 | 50 | 50 | 50 |
| component (ppb) | | | | | | |
| Sabinene (ppb) | 0 | 0 | 5.0 | 50 | 100 | 200 |
| Flavor of the whole | 5 | 1 | 3.0 | 3.4 | 4.0 | 4.0 |
| Light-deterioration | 5 | 1 | 2.8 | 3.4 | 4.0 | 4.0 |
| odor | | | | | | |

As shown in Table 3a and FIG. 3a, in the beverages of Examples 9 to 12, a light-deterioration odor became harder to feel, and the flavor of the whole was improved, as compared with those in the deteriorated product (Reference Example 9) comprising no sabinene.

### Evaluation 3-2 (Effect of γ-Terpinene on Light-Deterioration Odor in Sugar-Sweetened Carbonated Beverage)

In the step of adding raw materials in Reference Example 9 in Evaluation 1-2, γ-terpinene was further added to blend the γ-terpinene into the sugar-sweetened carbonated beverage of Reference Example 9. Except for this, sugar-sweetened carbonated beverages (colorless and transparent) of Examples 13 to 16 shown in Table 3b below were obtained in the same manner as in Reference Example 9.

For comparison with the beverages of Examples 13 to 16, Reference Example 6 and Reference Example 9 in Evaluation 1-2 were prepared, and these were taken to be an undeteriorated product (Reference Example 6) and a deteriorated product (Reference Example 9).

Five panelists tasted the carbonated beverages of Examples 13 to 16, and they evaluated “flavor of whole beverage” and “light-deterioration odor” based on the same evaluation criteria as in Evaluation 3-1.

The evaluation results of the carbonated beverages of Examples 13 to 16 are shown in Table 3b and FIG. 3b.

TABLE 3b

| | Undeteriorated | Deteriorated | | | | |
|---|---|---|---|---|---|---|
| | product | product | | | | |
| Sugar-sweetened | (Reference | (Reference | Example | | | |
| carbonated beverage | Example 6) | Example 9) | 13 | 14 | 15 | 16 |
| Odor component (ppb) | 0 | 50 | 50 | 50 | 50 | 50 |
| γ-Terpinene (ppb) | 0 | 0 | 15 | 150 | 1500 | 2000 |
| Flavor of the whole | 5 | 1 | 3.4 | 4.0 | 2.8 | 2.4 |
| Light-deterioration odor | 5 | 1 | 3.4 | 4.0 | 4.4 | 4.6 |

As shown in Table 3b and FIG. 3b, in the beverages of Examples 13 to 16, a light-deterioration odor became harder to feel, and the flavor of the whole was improved, as compared with those in the deteriorated product (Reference Example 9) comprising no γ-terpinene.

### Evaluation 4-1 (Effect of Use of Sabinene and γ-Terpinene in Combination (Sugar-Free Carbonated Beverage))

In the step of adding raw materials in Reference Example 4 in Evaluation 1-1, sabinene and/or γ-terpinene were further added to blend the sabinene and/or the γ-terpinene into the sugar-free carbonated beverage of Reference Example 4. Except for this, sugar-free carbonated beverages (colorless and transparent) of Examples 17 to 21 shown in Table 4a below were obtained in the same manner as in Reference Example 4.

For comparison with the beverages of Examples 17 to 21, Reference Example 1 and Reference Example 4 in Evaluation 1-1 were prepared, and these were taken to be an undeteriorated product (Reference Example 1) and a deteriorated product (Reference Example 4).

Five panelists tasted the beverages of Examples 17 to 21, and they evaluated “flavor of whole beverage” and “light-deterioration odor” based on the same evaluation criteria as in Evaluation 2-1.

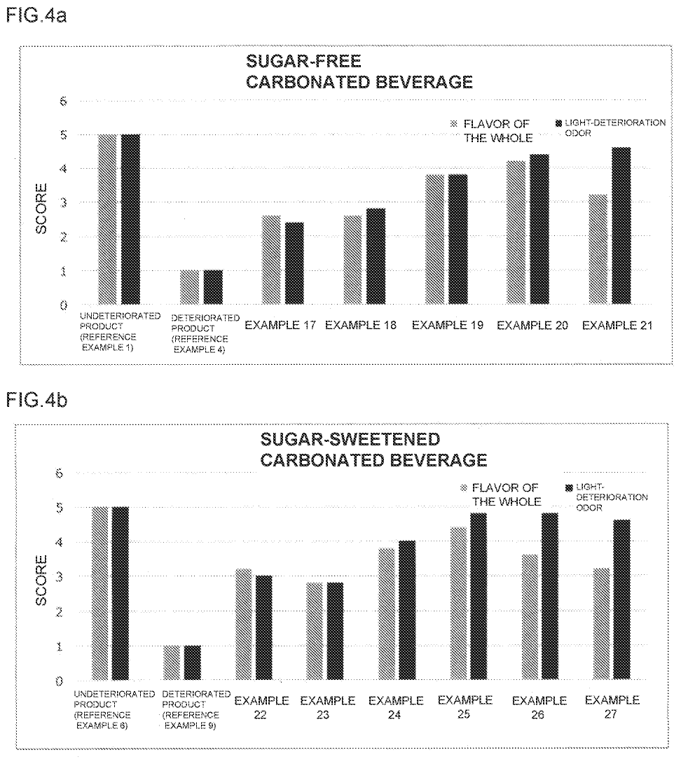

The evaluation results of the beverages of Examples 17 to 21 are shown in Table 4a and FIG. 4a.

TABLE 4a

| | Undeteriorated | Deteriorated | | | | | |
|---|---|---|---|---|---|---|---|
| | product | product | | | | | |
| Sugar-free | (Reference | (Reference | Example | | | | |
| carbonated beverage | Example 1) | Example 4) | 17 | 18 | 19 | 20 | 21 |
| Odor component | 0 | 50 | 50 | 50 | 50 | 50 | 50 |
| Sabinene (ppb) | — | — | 2.5 | — | 2.5 | 2.5 | 2.5 |
| γ-Terpinene (ppb) | — | — | — | 7.5 | 7.5 | 25 | 250 |
| Flavor of the whole | 5 | 1 | 2.6 | 2.6 | 3.8 | 4.2 | 3.2 |
| Light-deterioration odor | 5 | 1 | 2.4 | 2.8 | 3.8 | 4.4 | 4.6 |

As shown in Table 4a and FIG. 4a, in Examples 19 to 21 comprising both the sabinene and the γ-terpinene, a light-deterioration odor became harder to feel, and the flavor of the whole was improved, as compared with those in the deteriorated product (Reference Example 4) that did not comprise sabinene and γ-terpinene. Moreover, in Examples 17 and 18 each of which comprised only one of sabinene and γ-terpinene, a light-deterioration odor became harder to feel, and the flavor of the whole was improved, as compared with those in the deteriorated product (Reference Example 4) that did not comprise sabinene and γ-terpinene.

### Evaluation 4-2 (Effect of Use of Sabinene and γ-Terpinene in Combination (Sugar-Sweetened Carbonated Beverage))

In the step of adding raw materials in Reference Example 9 in Evaluation 1-2, sabinene and/or γ-terpinene were further added to blend the sabinene and/or the γ-terpinene into the sugar-sweetened carbonated beverage of Reference Example 9. Except for this, sugar-sweetened carbonated beverages (colorless and transparent) of Examples 22 to 27 shown in Table 4b below were obtained in the same manner as in Reference Example 9.

For comparison with the beverages of Examples 22 to 27, Reference Example 6 and Reference Example 9 in Evaluation 1-2 were prepared, and these were taken to be an undeteriorated product (Reference Example 6) and a deteriorated product (Reference Example 9).

Five panelists tasted the beverages of Examples 22 to 27, and they evaluated “flavor of whole beverage” and “light-deterioration odor” based on the same evaluation criteria as in Evaluation 3-1.

The evaluation results of the carbonated beverages of Examples 22 to 27 are shown in Table 4b and FIG. 4b.

TABLE 4b

| | Undeteriorated | Deteriorated | | | | | | |
|---|---|---|---|---|---|---|---|---|
| | product | product | | | | | | |
| Sugar-sweetened | (Reference | (Reference | Example | | | | | |
| carbonated beverage | Example 6) | Example 9) | 22 | 23 | 24 | 25 | 26 | 27 |
| Odor component | 0 | 50 | 50 | 50 | 50 | 50 | 50 | 50 |
| Sabinene (ppb) | — | — | 2.5 | — | 2.5 | 2.5 | 2.5 | — |
| γ-Terpinene (ppb) | — | — | — | 7.5 | 7.5 | 25 | 250 | 250 |
| Flavor of the whole | 5 | 1 | 3.2 | 2.8 | 3.8 | 4.4 | 3.6 | 3.2 |
| Light-deterioration odor | 5 | 1 | 3 | 2.8 | 4 | 4.8 | 4.8 | 4.6 |

As shown in Table 4b and FIG. 4b, in Examples 24 to 26 comprising both the sabinene and the γ-terpinene, a light-deterioration odor became harder to feel, and the flavor of the whole was improved, as compared with those in the deteriorated product (Reference Example 9) that did not comprise sabinene and γ-terpinene. Also, in Examples 22, 23, and 27 each of which comprised only one of sabinene and γ-terpinene, a light-deterioration odor became harder to feel, and the flavor of the whole was improved, as compared with those in the deteriorated product (Reference Example 9) that did not comprise sabinene and γ-terpinene.

1. A beverage comprising an unsaturated fatty acid, comprising:
2.5 to 500 ppb of sabinene and/or 5 to 5000 ppb of γ-terpinene.

2. The beverage according to claim 1, comprising 0.5 to 500 ppb of (E)-2-decenal.

3. The beverage according to claim 1, comprising both the sabinene and the γ-terpinene.

4. The beverage according to claim 3, wherein a content ratio between the sabinene and the γ-terpinene (sabinene:γ-terpinene) is 1:3 to 1:200.

5. The beverage according to claim 1, wherein the beverage is packed in a container having light transmission properties.

6. The beverage according to claim 1, wherein the beverage is a carbonated beverage.

7. The beverage according to claim 1, wherein the beverage is a sugar-sweetened beverage.

8. The beverage according to claim 1, wherein the beverage is a sugar-free beverage.

9. A method for producing a beverage comprising an unsaturated fatty acid, comprising:
blending sabinene in such an amount that the content of the sabinene in the beverage becomes 2.5 to 500 ppb and/or γ-terpinene in such an amount that the content of the γ-terpinene in the beverage becomes 5 to 5000 ppb.

10. A method of masking a light-deterioration odor in a beverage comprising an unsaturated fatty acid, comprising:
blending sabinene in such an amount that the content of the sabinene in the beverage becomes 2.5 to 500 ppb and/or γ-terpinene in such an amount that the content of the γ-terpinene in the beverage becomes 5 to 5000 ppb.

11. (canceled)
